(19) United States
(12) Patent Application Publication
(10) Pub. No.: US 2016/0341358 A1
(43) Pub. Date: Nov. 24, 2016

(54) SUPPORT APPARATUS

(71) Applicant: Richard J. Daley, Coquitlam (CA)

(72) Inventor: Richard J. Daley, Coquitlam (CA)

(21) Appl. No.: 15/002,675

(22) Filed: Jan. 21, 2016

Related U.S. Application Data
(60) Provisional application No. 62/105,814, filed on Jan. 21, 2015.

(51) Int. Cl. F16M 13/02; F16M 11/08

(52) U.S. Cl. CPC F16M 13/022; F16M 11/08

(57) ABSTRACT

Embodiments herein include a support apparatus for receiving and supporting a wheel or other component removed from a vehicle. The support apparatus comprises a cross member coupled to first and second brackets or clamps. The brackets are configured to allow positioning of the support apparatus on a support member of a hoist or rack, and to secure the support apparatus to the hoist or rack in the selected position. A hanger component is coupled to at least one of the cross member, the first bracket, and the second bracket. The hanger component, which includes a support arm assembly, is configured to receive and support the wheel/tire.

### RELATED APPLICATION

This application claims the benefit of U.S. Patent Application No. 62/105,814, filed Jan. 21, 2015.

### TECHNICAL FIELD

The embodiments described herein relate to a support apparatus configured for attachment to a structure and, more particularly, a support apparatus for receiving and supporting a wheel removed from a vehicle.

### BACKGROUND

Vehicle maintenance is often performed by placing the subject vehicle on a lift or hoist to provide improved access to components of the vehicle. The vehicle maintenance and/or access may involve removal of one or more of the wheels/tires (“wheels”). Numerous conventional devices have been available to assist individuals in handling wheel assemblies when removing from and/or mounting to a hoisted vehicle. These conventional devices include, for example, various types of lifts and/or carts for lifting and handling the wheels. While these conventional devices may assist workers in removing and mounting tires/wheels from a vehicle, these devices can introduce additional limitations.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1A shows the support apparatus attached to a vertical structure, wherein the support apparatus includes two hanger components in a stowed state, under an embodiment.

FIG. 1B shows the support apparatus attached to a vertical structure, wherein the support apparatus includes a first hanger component in a stowed state and a second hanger component in a deployed state, under an embodiment.

FIG. 1C is a view of a hanger component deployed from the support apparatus, under an embodiment.

FIG. 1D is a front perspective view of the support apparatus attached to a vertical structure, wherein one hanger component is in a deployed state and is supporting a wheel/tire, under an embodiment.

FIG. 1E is a side perspective view of the support apparatus attached to a vertical structure, wherein one hanger component is in a deployed state and is supporting a wheel/tire, under an embodiment.

FIG. 2 is a close-up view of the hinge assembly attached to a bracket of the support apparatus (hanger component stowed), under an embodiment.

FIG. 3 is an alternative close-up view of the hinge assembly attached to a bracket of the support apparatus (hanger component deployed), showing the support apparatus secured to the vertical structure, under an embodiment.

FIG. 4 is a top view of the hinge assembly attached to a bracket of the support apparatus (hanger component deployed), showing the support apparatus secured to the vertical structure, under an embodiment.

FIG. 5 is a specification drawing of the support apparatus including the first and second brackets and the cross member, under an embodiment.

FIG. 6 is a specification drawing of the cross member of the support apparatus, under an embodiment.

FIG. 7 is a specification drawing of the bracket (first and second) of the support apparatus, under an embodiment.

FIG. 8 is a specification drawing of the insert of the support apparatus, under an embodiment.

FIG. 9 is a specification drawing of the tapped plug component of the support apparatus, under an embodiment.

FIG. 10 is a specification drawing of the hanger bracket of the support apparatus, under an embodiment.

FIG. 11 shows attachment of the first bracket to the cross member, and attachment of the hanger bracket to the first bracket, under an embodiment.

FIG. 12 shows attachment of the hanger component to the hinge assembly, under an embodiment.

FIG. 13 is a specification drawing of the support apparatus, under an alternative embodiment.

FIG. 14 is a specification drawing of the cross member, under the alternative embodiment.

FIG. 15 is a specification drawing of the clamp, under the alternative embodiment.

FIG. 16 is a specification drawing of the parts tray, under the alternative embodiment.

FIG. 17 is a specification drawing of the hinge, under the alternative embodiment.

FIG. 18 is a specification drawing of the first arm assembly, under the alternative embodiment.

FIG. 19 is a specification drawing of the second arm assembly, under the alternative embodiment.

FIG. 20 is a specification drawing of the arm socket of the arm assembly, under the alternative embodiment.

FIG. 21 is a specification drawing of the support arm of the first arm assembly, under the alternative embodiment.

FIG. 22 is a specification drawing of the support arm of the second arm assembly, under the alternative embodiment.

FIG. 23 is a specification drawing of the arm end pin of the support arm, under to the alternative embodiment.

### DETAILED DESCRIPTION

Embodiments described herein include a support apparatus for receiving and supporting a wheel or other component removed from a vehicle. The support apparatus of an embodiment comprises a cross member comprising a first end and a second end. The apparatus includes a first bracket comprising a first end configured to be fastened to the first end of the cross member and a second end configured to be free of attachment. The apparatus includes a second bracket comprising a first end configured to be fastened to the second end of the cross member and a second end configured to be free of attachment. The first bracket and the second bracket are configured for positional adjustment relative to a position of the cross member and a vertical support of a hoist. An assembly comprising the cross member fastened to the first bracket and the second bracket is configured to exert a securing force that secures the assembly to the vertical support of the hoist member. The apparatus includes a hanger component coupled to at least one of the cross member, the first bracket, and the second bracket.

In the following description, numerous specific details are introduced to provide a thorough understanding of, and enabling description for, the systems and methods described. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

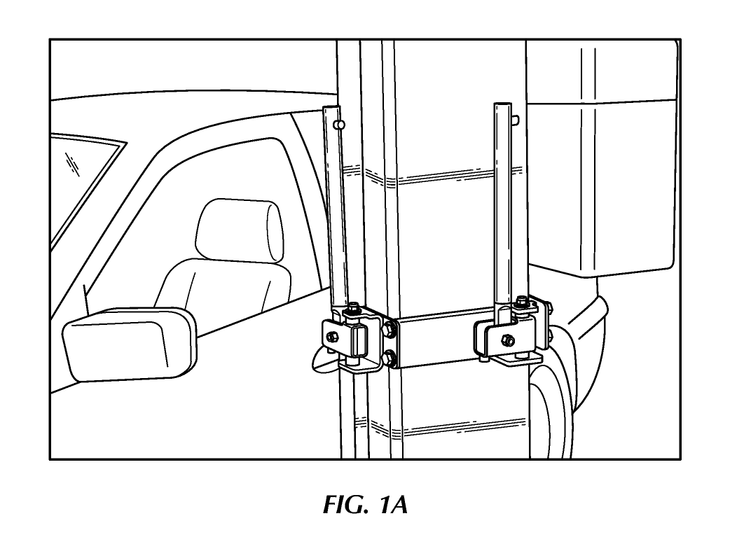

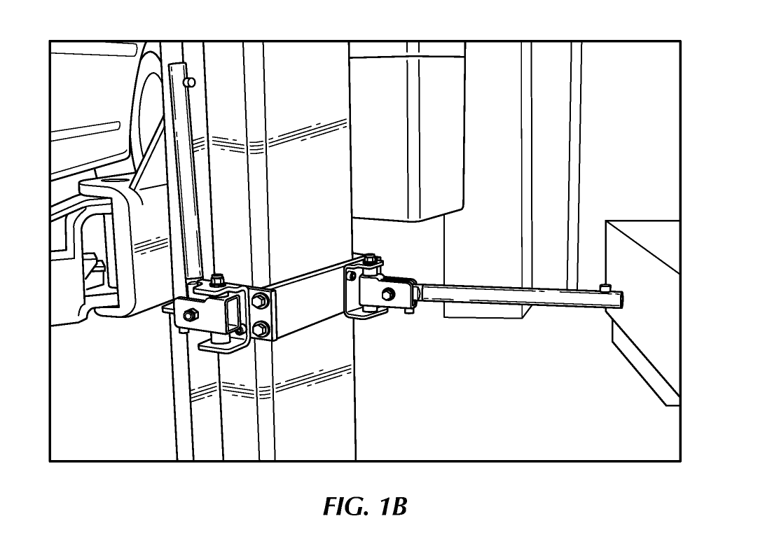

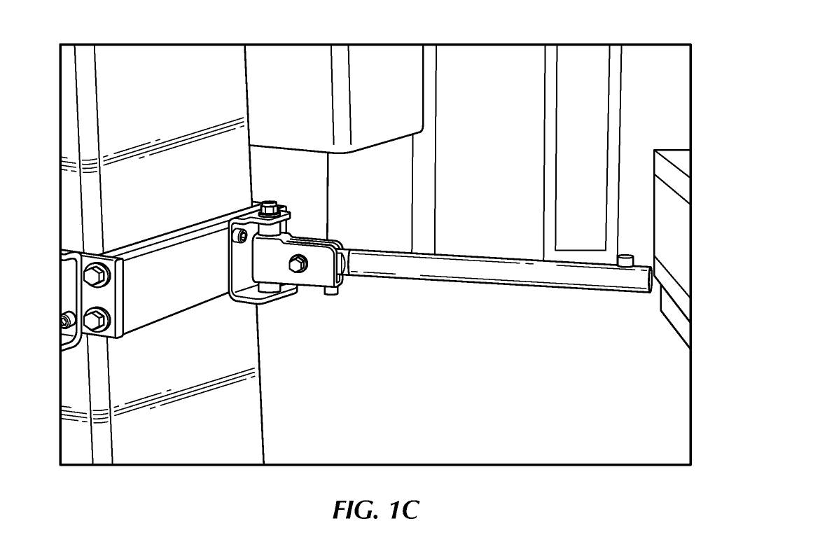

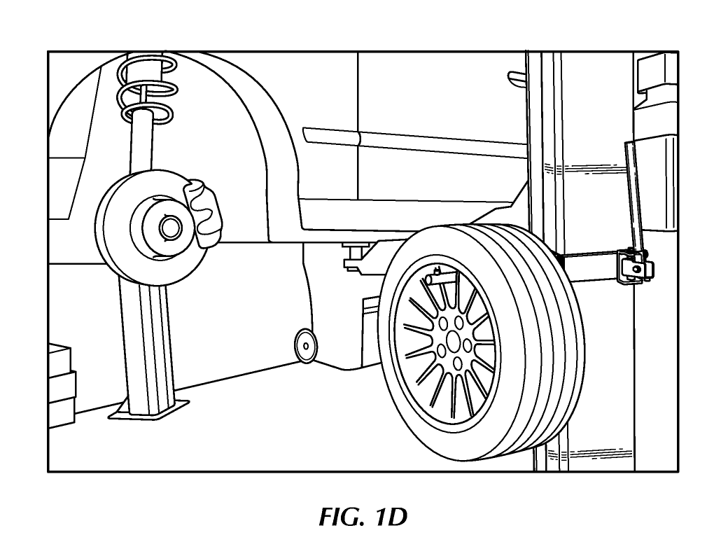

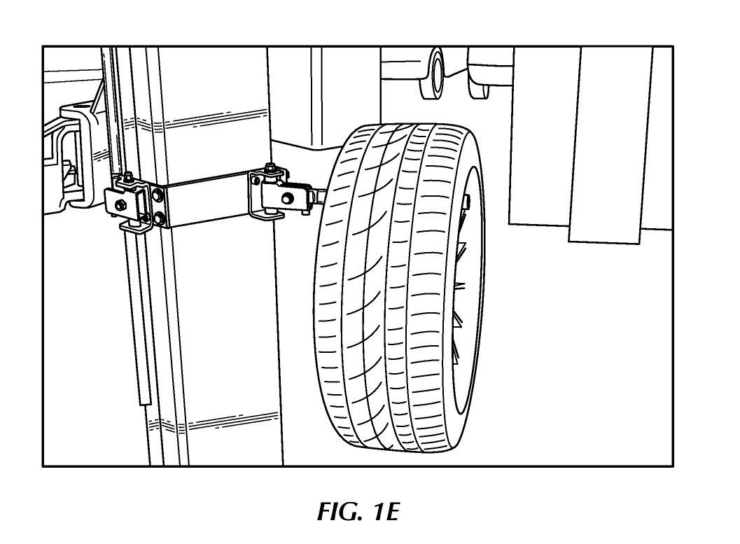

FIG. 1A shows the support apparatus attached to a vertical structure, wherein the support apparatus includes two hanger components in a stowed state, under an embodiment.

FIG. 1B shows the support apparatus attached to a vertical structure, wherein the support apparatus includes a first hanger component in a stowed state and a second hanger component in a deployed state, under an embodiment.

FIG. 1C is a view of a hanger component deployed from the support apparatus, under an embodiment.

FIG. 1D is a front perspective view of the support apparatus attached to a vertical structure, wherein one hanger component is in a deployed state and is supporting a wheel/tire, under an embodiment.

FIG. 1E is a side perspective view of the support apparatus attached to a vertical structure, wherein one hanger component is in a deployed state and is supporting a wheel/tire, under an embodiment.

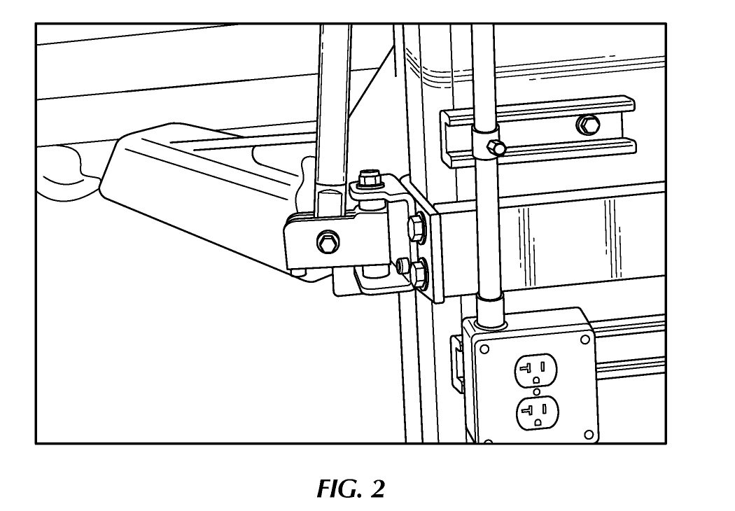

FIG. 2 is a close-up view of the hinge assembly attached to a bracket of the support apparatus (hanger component stowed), under an embodiment.

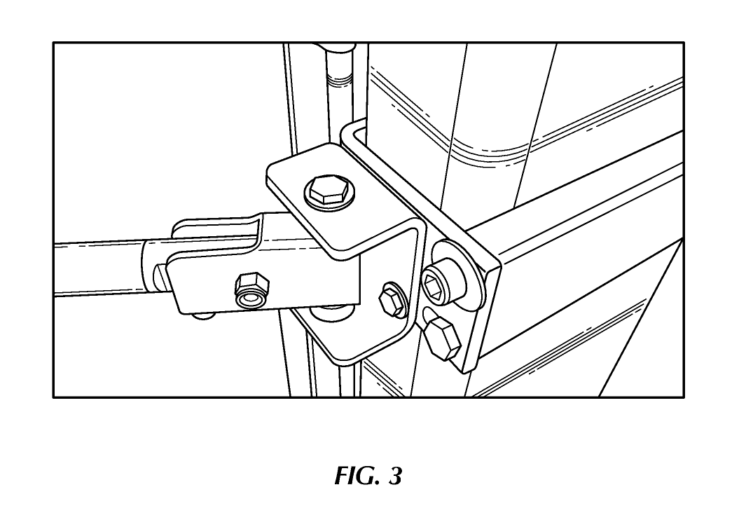

FIG. 3 is an alternative close-up view of the hinge assembly attached to a bracket of the support apparatus (hanger component deployed), showing the support apparatus secured to the vertical structure, under an embodiment.

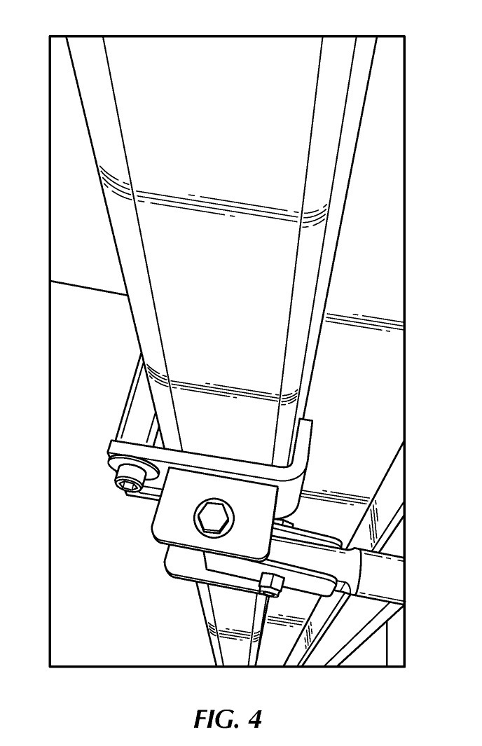

FIG. 4 is a top view of the hinge assembly attached to a bracket of the support apparatus (hanger component deployed), showing the support apparatus secured to the vertical structure, under an embodiment.

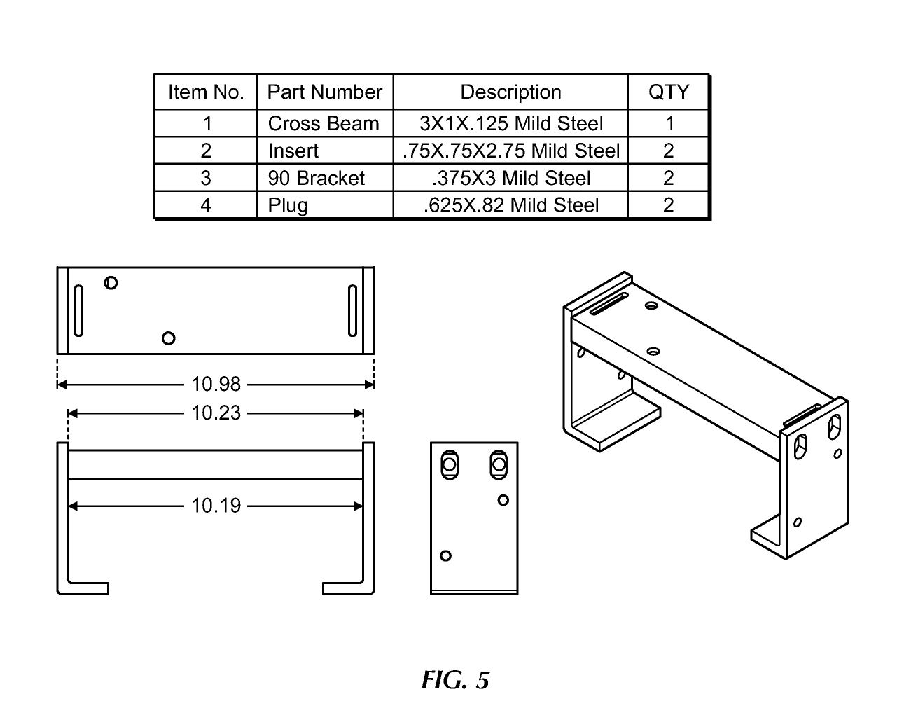

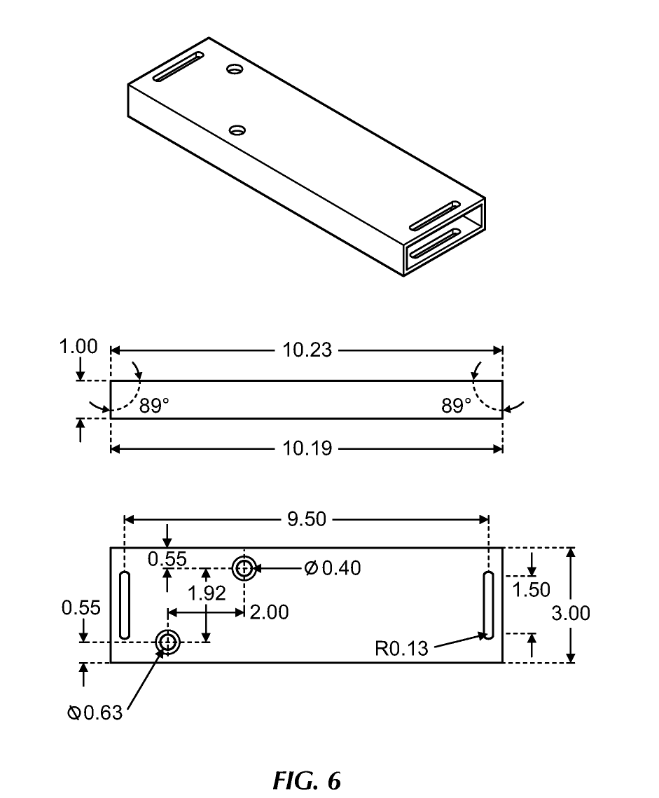

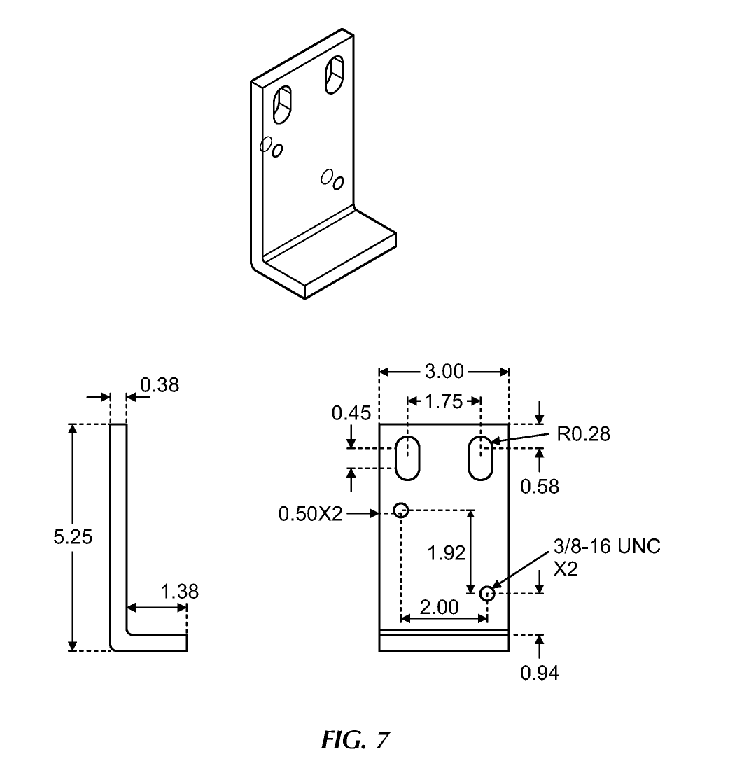

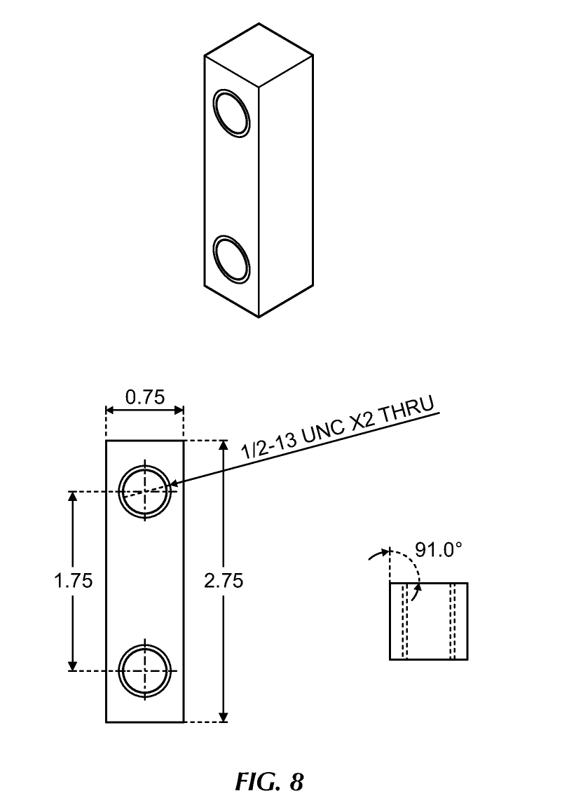

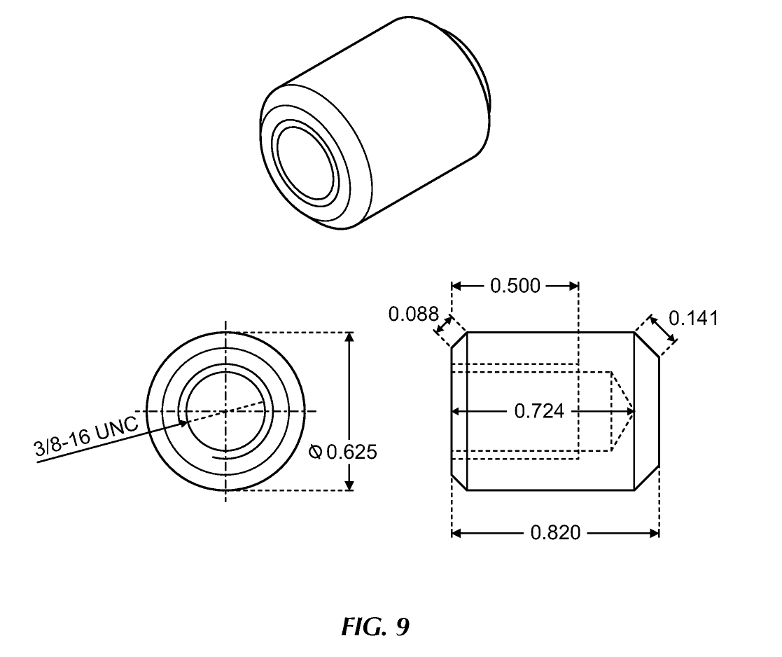

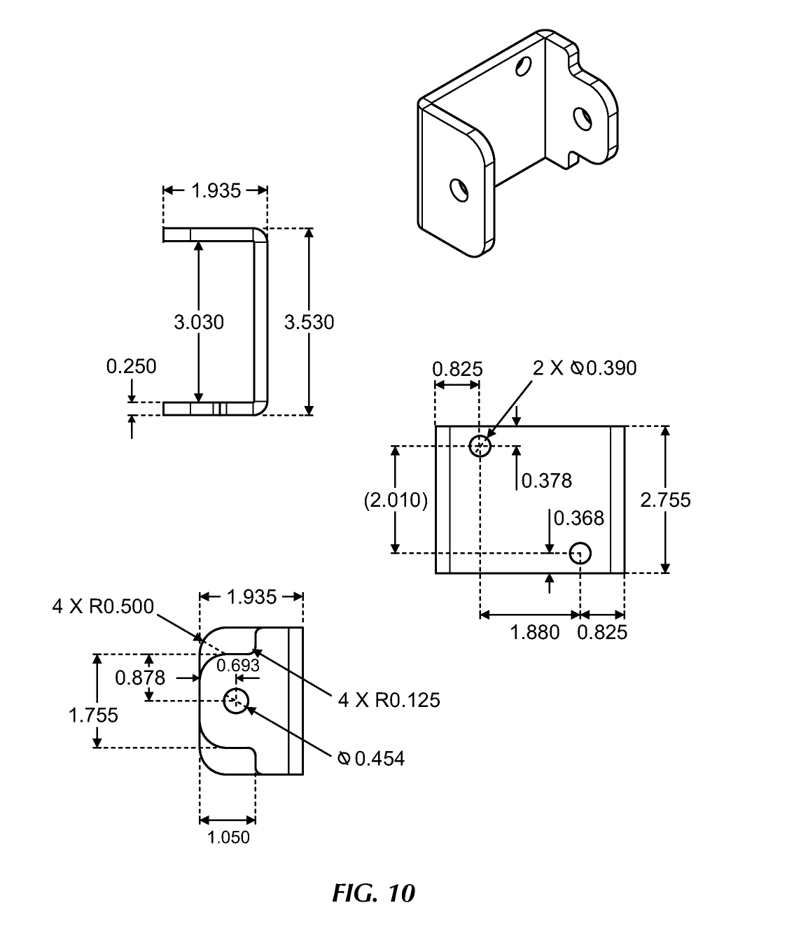

FIGS. 5-10 show components of the support apparatus. More specifically, FIG. 5 is a specification drawing of the support apparatus including the first and second brackets and the cross member, under an embodiment. FIG. 6 is a specification drawing of the cross member of the support apparatus, under an embodiment. FIG. 7 is a specification drawing of the bracket (first and second) of the support apparatus, under an embodiment. FIG. 8 is a specification drawing of the insert of the support apparatus, under an embodiment. FIG. 9 is a specification drawing of the tapped plug component of the support apparatus, under an embodiment. FIG. 10 is a specification drawing of the hanger bracket of the support apparatus, under an embodiment.

With reference to FIGS. 5-10, the first end of the first bracket is fastened to the first end of the cross member. The second end of the first bracket remains free of attachment. The first end of the second bracket is fastened to the second end of the cross member. The second end of the second bracket remains free of attachment. The assembly comprising the cross member attached to the first bracket and the second bracket is placed or assembled on a vertical support structure, which in an embodiment is a vertical support of a hoist (e.g., automobile hoist). A position of the assembly is adjusted to a desired height on the vertical support, and the fastening mechanism is secured to secure the position of the assembly on the vertical support. When securely fastened, the assembly comprising the cross member fastened to the first bracket and the second bracket exerts a securing force that secures the assembly to the vertical support.

The support apparatus also includes one or more hanger components coupled to the cross member, the first bracket, and/or the second bracket as appropriate to a desired configuration. Various embodiments possible hereunder include a single hanger component is attached to the cross member, a single hanger component is attached to the first bracket, a single hanger component is attached to the second bracket, a hanger component attached to each of the first and second brackets, a hanger component attached to each of the cross member and the first bracket, a hanger component attached to each of the cross member and the second bracket, and a hanger component attached to each of the cross member, the first bracket, and the second bracket, to name a few.

The hanger component of an embodiment is configured for hanging a wheel on the hoist member. Referring to FIG. 3, the hanger component comprises a clevis comprising a top plate that is substantially parallel to a bottom plate and connected to the bottom plate with a base plate, and a support arm having a distal end and a proximal end.

The support arm is coupled to the clevis with a hinge assembly. The hinge assembly comprises a connector coupled to a first hinge and a second hinge. The connector comprises a proximal end and a distal end, and the distal end includes a recess configured to rotatably receive the proximal end of the support arm. The first hinge rotateably couples the connector to the clevis, and the second hinge rotateably couples the support arm to the connector. The support arm is rotatable about the first hinge and the second hinge such that the first hinge enables movement of the support arm in a first plane, and the second hinge enables movement of the support arm in a second plane.

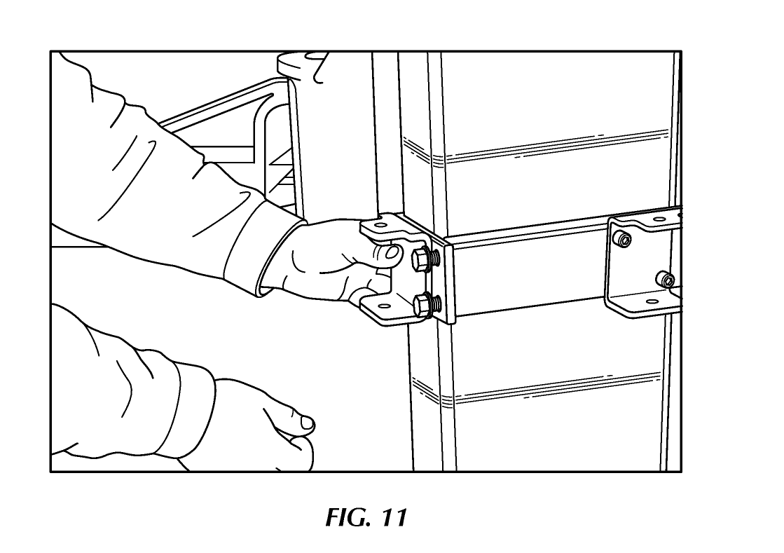

FIG. 11 shows attachment of the first bracket to the cross member, and attachment of the hanger bracket to the first bracket, under an embodiment.

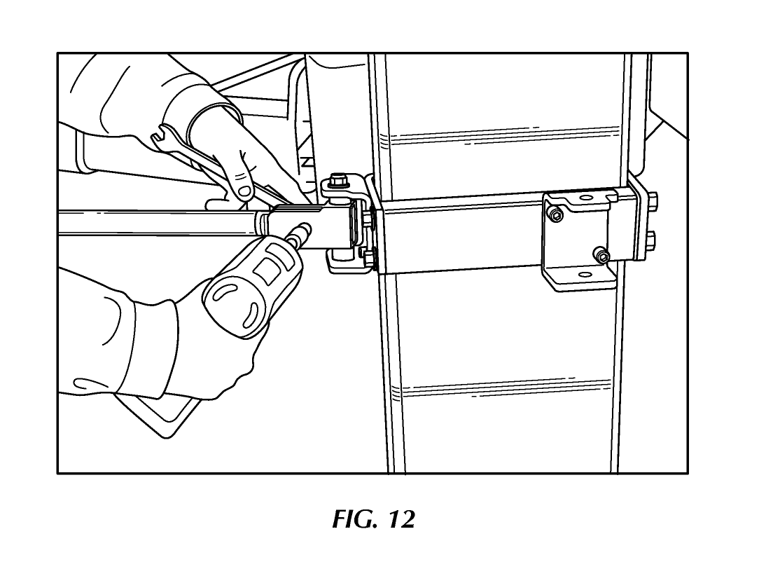

FIG. 12 shows attachment of the hanger component to the hinge assembly, under an embodiment.

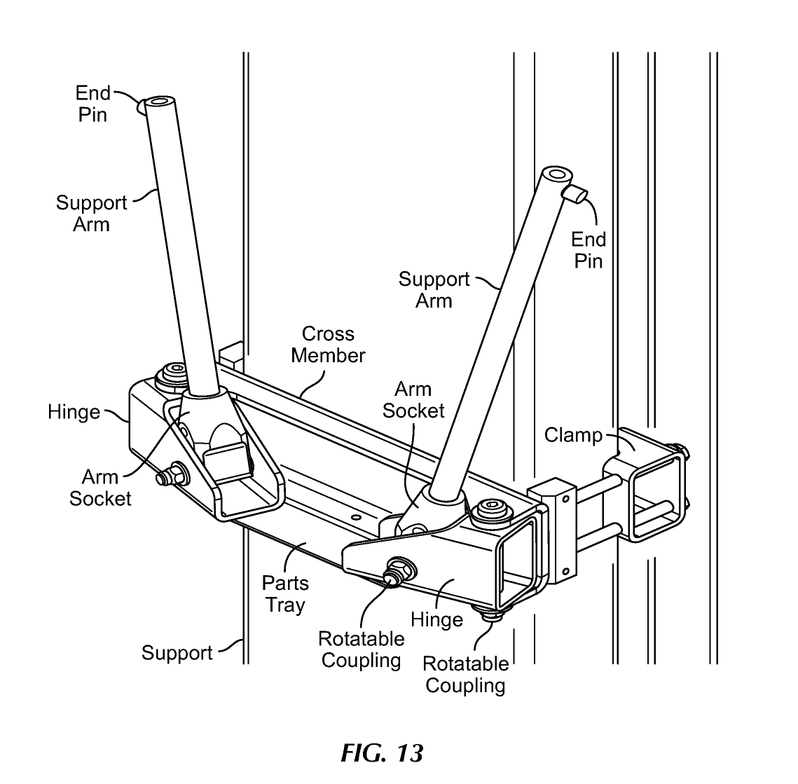

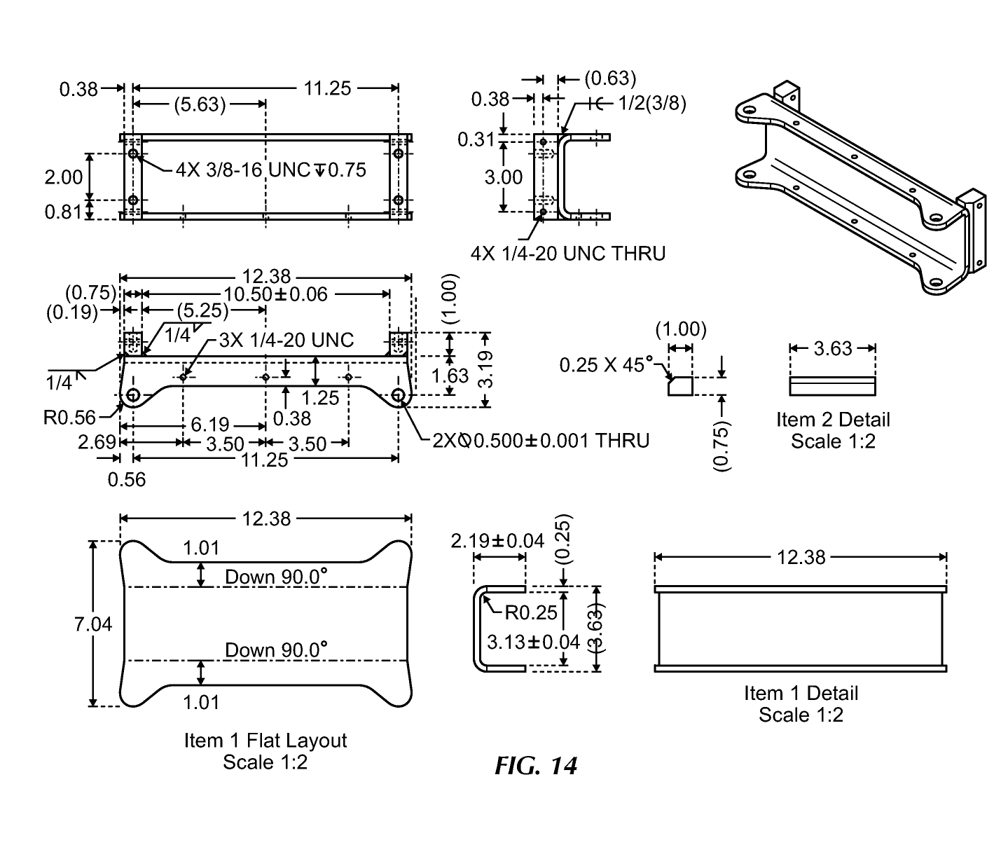

The support apparatus of another embodiment comprises a single-hinge configuration. FIG. 13 is a specification drawing of the support apparatus, under an alternative embodiment. FIGS. 14-23 show individual components of the support apparatus of the alternative embodiment. While FIGS. 14-23 show the alternative embodiment including two support arm assemblies, the embodiment is not so limited as additional alternative embodiments include a lesser or greater number of support arm assemblies. The support apparatus of the alternative embodiment includes a cross member, and at least one clamp comprising a first end configured to be fastened to the cross member and a second end configured to make secure contact with a vertical support structure. A hinge includes a proximal end and a distal end, and the proximal end is configured to be coupled to the cross member to rotate around the cross member coupling in a first plane. A support arm assembly, which includes a socket and a support arm extending from the socket, is coupled to the cross member using the hinge. The socket, which is configured to be coupled to the distal end of the hinge, is configured to rotate around the hinge coupling in a second plane that is different from the first plane.

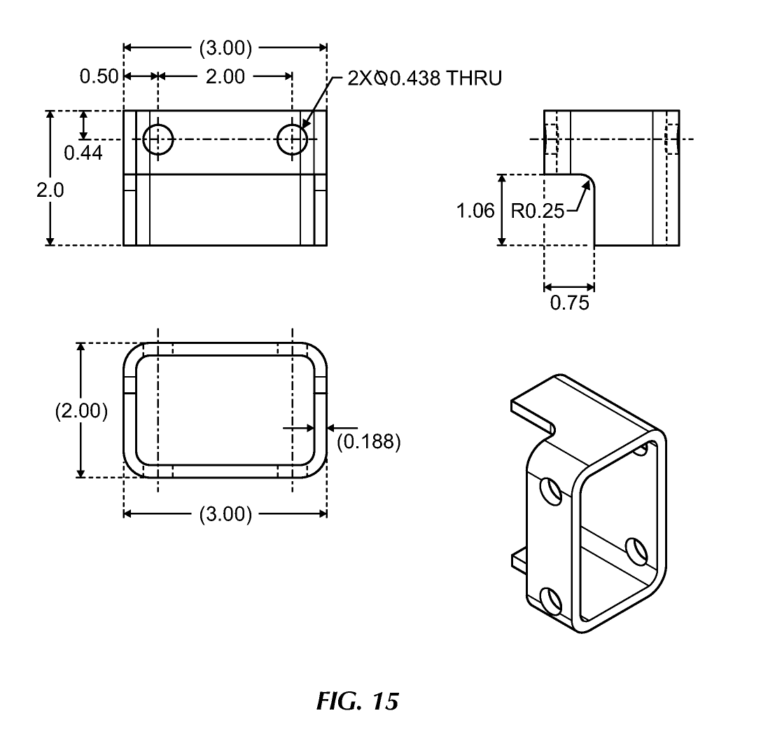

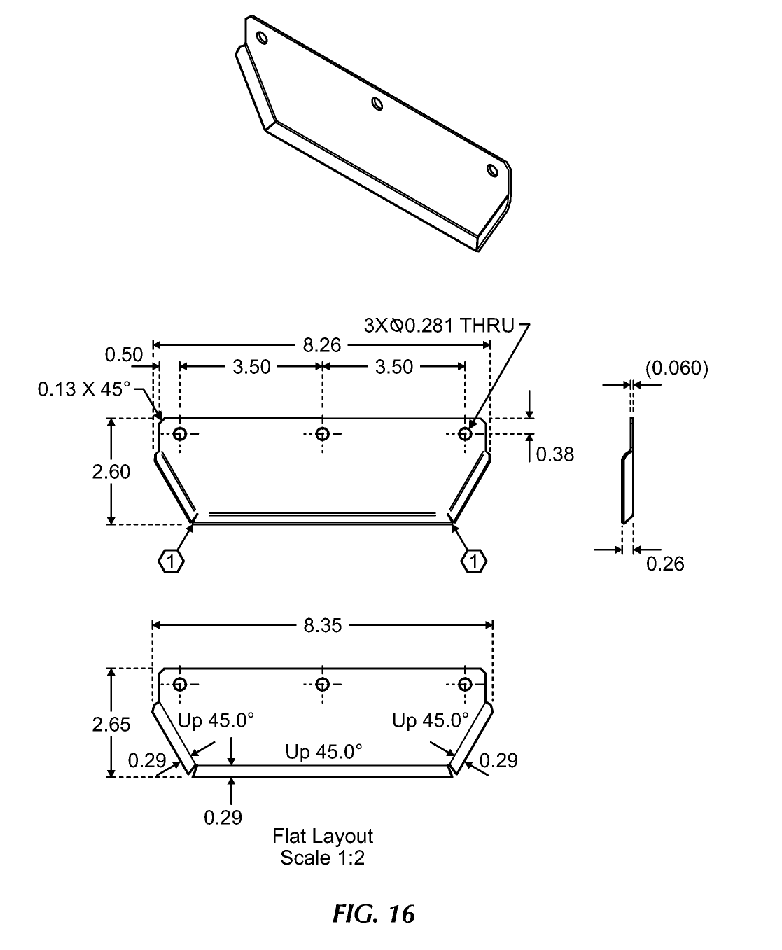

The support apparatus can include an additional hinge comprising a proximal end configured to be coupled to the cross member to rotate around the cross member coupling in the first plane. An additional support arm assembly is coupled to the additional hinge and includes an additional socket and an additional support arm extending from the socket. The additional socket is configured to be coupled to a distal end of the additional hinge to rotate around the additional hinge coupling in the second plane. More specifically, FIG. 14 is a specification drawing of the cross member, under the alternative embodiment. FIG. 15 is a specification drawing of the clamp, under the alternative embodiment. FIG. 16 is a specification drawing of a parts tray, under the alternative embodiment. The support apparatus is configured to be secured in a position on a vertical support using two clamps, for example. Consequently, the cross member is configured so a first clamp secures a first end of the cross member to the vertical support, and a second clamp secures a second end of the cross member to the vertical support. A position of the assembly is adjusted to a desired height on the vertical support, and the fastening mechanism is secured to secure the position of the assembly on the vertical support. When securely fastened, the assembly comprising the cross member fastened to the first clamp and the second clamp exerts a securing force that secures the assembly to the vertical support. The parts tray is configured to be attached to a lower or bottom region of the cross member.

The support apparatus also includes one or more support arm components coupled to the cross member, the first clamp, and/or the second clamp as appropriate to a desired configuration. Various embodiments possible hereunder include a single support arm attached to the cross member, a plurality of support arms attached to the cross member, a single support arm attached to the first clamp, a single support arm attached to the second clamp, a support arm attached to each of the first and second clamps, a support arm attached to each of the cross member and the first claim, a support arm attached to each of the cross member and the second clamp, and a support arm attached to each of the cross member, the first clamp, and the second clamp, to name a few.

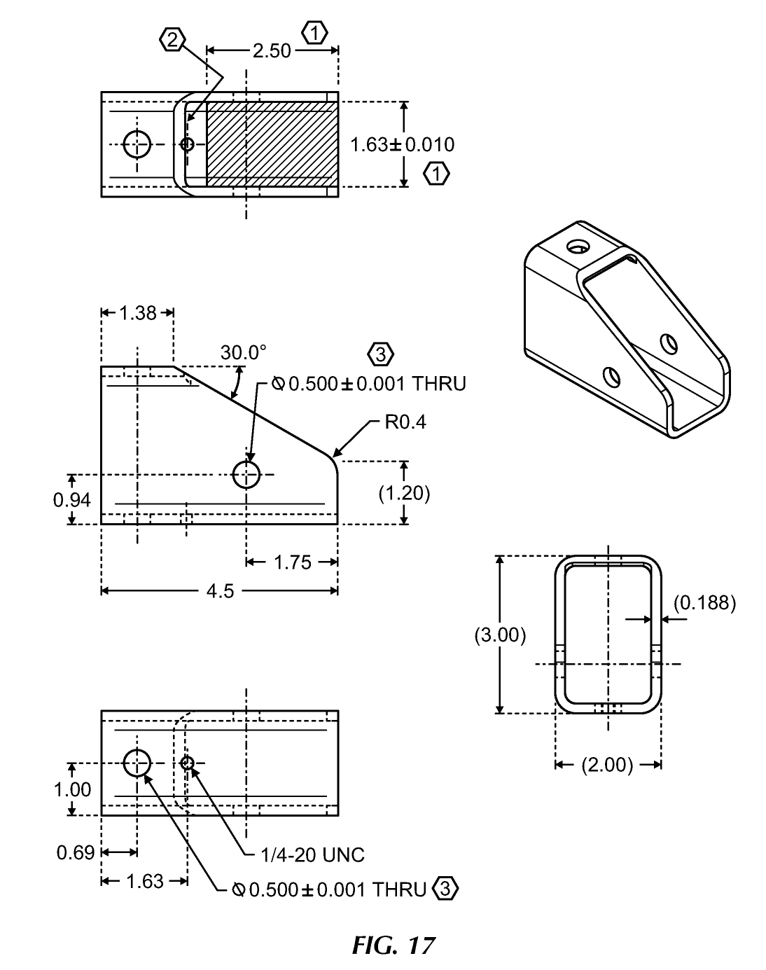

The support apparatus includes a support arm assembly on each end of the cross member, but the embodiment is not so limited. Each support arm assembly is coupled or connected to the cross member using a hinge. FIG. 17 is a specification drawing of the hinge, under the alternative embodiment. A proximal end of a first hinge is rotatably coupled to a first end of the cross member, and the proximal end of a second hinge is rotatably coupled to a second end of the cross member. The rotatable coupling of each hinge with the cross member is configured to support rotation of that hinge in a first plane with respect to the cross member.

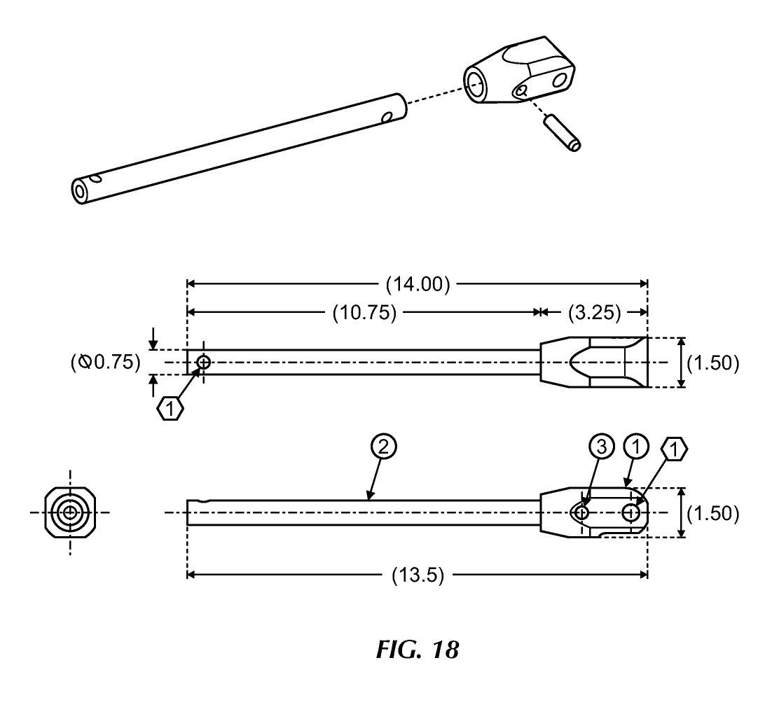

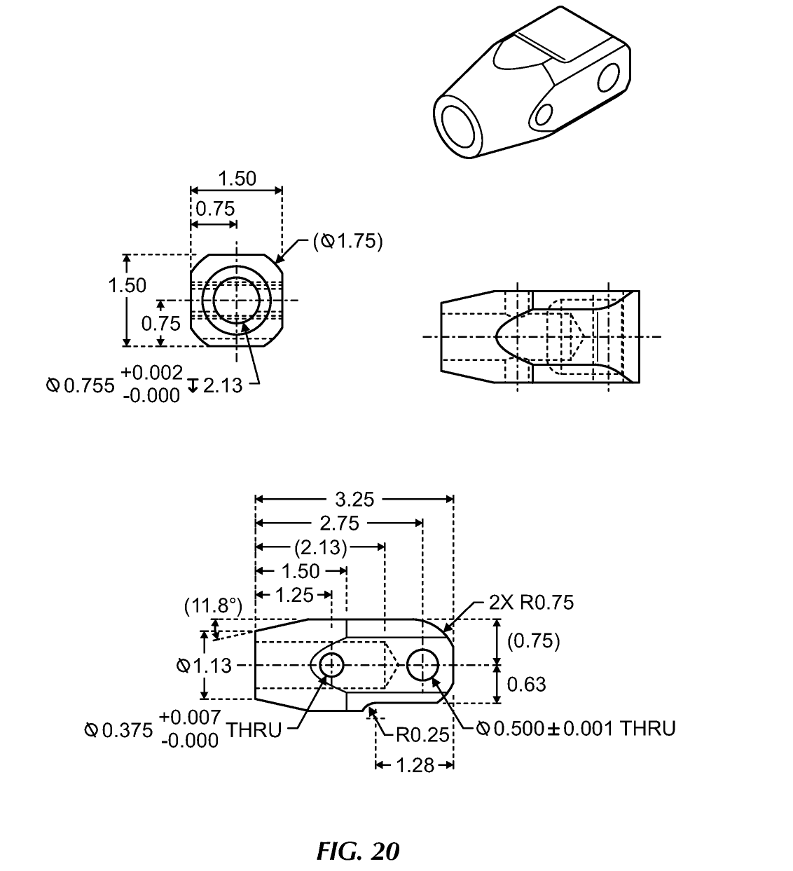

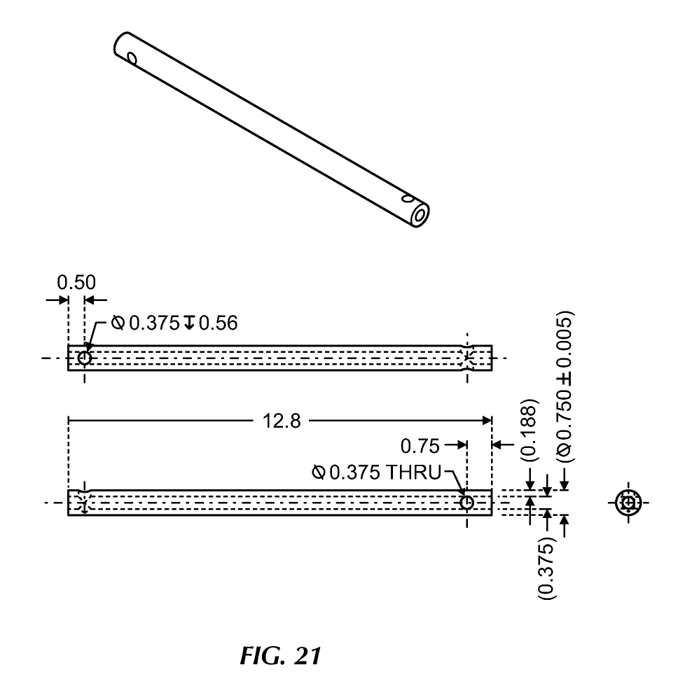

The support apparatus includes one or more support arm assemblies. FIG. 18 is a specification drawing of a first support arm assembly, under the alternative embodiment. The first support arm assembly includes a support arm coupled or connected to an arm socket or socket. The arm socket is rotatably coupled or connected to a distal end of the respective hinge in a manner configured to support rotation of the support arm in a second plane with respect to the hinge, where the second plane of rotation is different than the first plane of rotation of the hinge. The first support arm assembly has a length of approximately 13.5 inches, but is not so limited and can have any length as appropriate to a configuration of the support apparatus. The support arm of the first support arm assembly has a length of approximately 10.75 inches, but is not so limited. FIG. 20 is a specification drawing of the arm socket of the arm assembly, under the alternative embodiment. FIG. 21 is a specification drawing of the support arm of the first arm assembly, under the alternative embodiment.

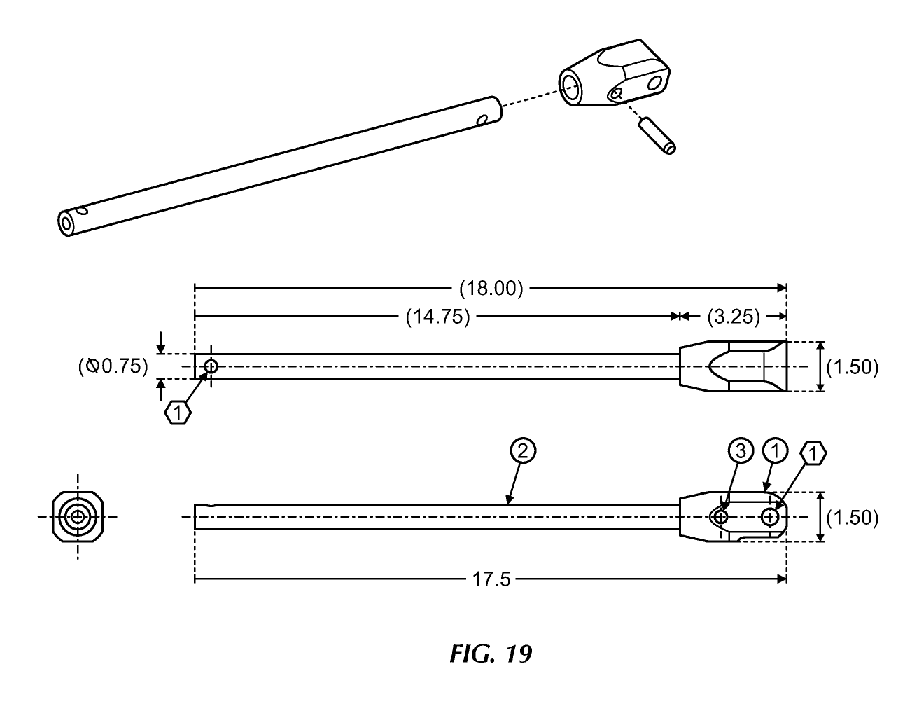

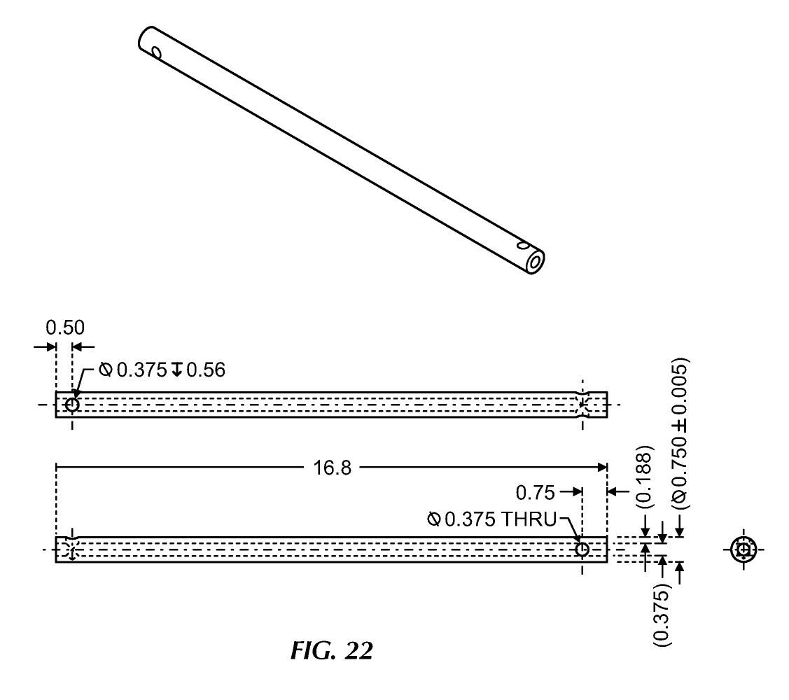

FIG. 19 is a specification drawing of the second support arm assembly, under the alternative embodiment. The second support arm assembly includes a support arm coupled or connected to an arm socket, and the arm socket is rotatably coupled or connected to a distal end of the respective hinge. The second support arm assembly has a length of approximately 17.5 inches, but is not so limited. The support arm of the second support arm assembly has a length of approximately 14.75 inches, but is not so limited. FIG. 22 is a specification drawing of the support arm of the second arm assembly, under the alternative embodiment.

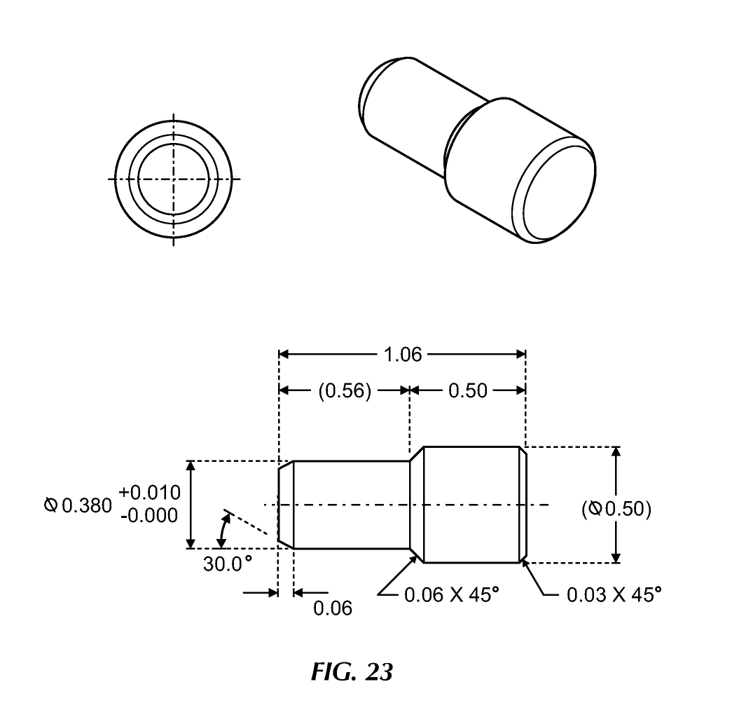

FIG. 23 is a specification drawing of the arm end-pin of the support arm, under the alternative embodiment. Each support arm includes an end-pin coupled or connected to an upper face of the end region of the support arm.

Embodiments described herein include an apparatus comprising a cross member. The embodiment includes a clamp comprising a first end configured to be fastened to the cross member and a second end configured to make secure contact with a vertical support structure. The embodiment includes a hinge comprising a proximal end and a distal end. The proximal end is configured to be coupled to the cross member to rotate around the cross member coupling in a first plane. The apparatus includes a support arm assembly comprising a socket and a support arm extending from the socket. The socket is configured to be coupled to the distal end of the hinge to rotate around the hinge coupling in a second plane that is different from the first plane.

Embodiments described herein include an apparatus comprising a cross member, a clamp comprising a first end configured to be fastened to the cross member and a second end configured to make secure contact with a vertical support structure, a hinge comprising a proximal end and a distal end, wherein the proximal end is configured to be coupled to the cross member to rotate around the cross member coupling in a first plane, and a support arm assembly comprising a socket and a support arm extending from the socket, wherein the socket is configured to be coupled to the distal end of the hinge to rotate around the hinge coupling in a second plane that is different from the first plane.

The apparatus includes an additional clamp configured to fasten the cross member to the vertical support structure. The apparatus includes an additional hinge comprising a proximal end configured to be coupled to the cross member to rotate around the cross member coupling in the first plane. The apparatus includes an additional support arm assembly comprising an additional socket and an additional support arm extending from the socket, wherein the additional socket is configured to be coupled to a distal end of the additional hinge to rotate around the additional hinge coupling in the second plane.

The apparatus includes a parts tray configured to be coupled to the cross member.

Embodiments described herein include an apparatus comprising a cross member comprising a first end and a second end. The apparatus includes a first bracket comprising a first end configured to be fastened to the first end of the cross member and a second end configured to be free of attachment. The apparatus includes a second bracket comprising a first end configured to be fastened to the second end of the cross member and a second end configured to be free of attachment. The first bracket and the second bracket are configured for positional adjustment relative to a position of the cross member and a vertical support of a hoist. An assembly comprising the cross member fastened to the first bracket and the second bracket is configured to exert a securing force that secures the assembly to the vertical support of the hoist member. The apparatus includes a hanger component coupled to at least one of the cross member, the first bracket, and the second bracket.

Embodiments described herein include an apparatus comprising: a cross member comprising a first end and a second end; a first bracket comprising a first end configured to be fastened to the first end of the cross member and a second end configured to be free of attachment; a second bracket comprising a first end configured to be fastened to the second end of the cross member and a second end configured to be free of attachment, wherein the first bracket and the second bracket are configured for positional adjustment relative to a position of the cross member and a vertical support of a hoist, wherein an assembly comprising the cross member fastened to the first bracket and the second bracket is configured to exert a securing force that secures the assembly to the vertical support of the hoist member; and a hanger component coupled to at least one of the cross member, the first bracket, and the second bracket.

The cross member comprises a first insert in the first end and a second insert in the second end. Each of the first insert and the second insert are configured to receive at least one fastener that fastens the first bracket and the second bracket to the cross member.

The first end of each of the first bracket and the second bracket comprises at least one aperture that is configured to receive the at least one fastener and control the positional adjustment of each of the first bracket and the second bracket relative to the cross member.

The cross member comprises a tubular member.

The first bracket comprises an L-shaped bracket formed as a single component. The second bracket comprises an L-shaped bracket formed as a single component.

The assembly is configured to be selectively adjusted to a position along the vertical support of the hoist member.

The hanger component is configured for hanging a wheel on the hoist member.

The hanger component comprises a clevis comprising a top plate that is substantially parallel to a bottom plate and connected to the bottom plate with a base plate.

The hanger component comprises a support arm having a distal end and a proximal end, wherein the support arm is coupled to the clevis with a hinge assembly.

The hinge assembly comprises a connector coupled to a first hinge and a second hinge.

The connector comprises a proximal end and a distal end, wherein the distal end includes a recess configured to rotatably receive the proximal end of the support arm.

The first hinge rotateably couples the connector to the clevis, and the second hinge rotateably couples the support arm to the connector. The support arm is rotatable about the first hinge and the second hinge.

The hanger component is coupled to the cross member with at least one fastener.

Embodiments described herein include an apparatus comprising a cross member comprising a first end and a second end. Each of the first end and the second end include an insert configured to receive a fastener. The apparatus includes a first bracket comprising a first end configured to be fastened to the insert in the first end of the cross member. The apparatus includes a second bracket comprising a first end configured to be fastened to the insert in the second end of the cross member. The first bracket and the second bracket are configured for positional adjustment relative to a position of the cross member. An assembly comprising the cross member fastened to the first bracket and the second bracket is configured to exert a securing force that secures the assembly to a vertical support of a structure. The apparatus includes a hanger component coupled to at least one of the cross member, the first bracket, and the second bracket.

Embodiments described herein include an apparatus comprising: a cross member comprising a first end and a second end, wherein each of the first end and the second end include an insert configured to receive a fastener; a first bracket comprising a first end configured to be fastened to the insert in the first end of the cross member; a second bracket comprising a first end configured to be fastened to the insert in the second end of the cross member, wherein the first bracket and the second bracket are configured for positional adjustment relative to a position of the cross member, wherein an assembly comprising the cross member fastened to the first bracket and the second bracket is configured to exert a securing force that secures the assembly to a vertical support of a structure; and a hanger component coupled to at least one of the cross member, the first bracket, and the second bracket.

The assembly is configured to be selectively adjusted to a position along the vertical support.

The first bracket comprises an L-shaped bracket formed as a single component. The second bracket comprises an L-shaped bracket formed as a single component.

The hanger component comprises a clevis comprising a top plate that is substantially parallel to a bottom plate and connected to the bottom plate with a base plate.

The hanger component comprises a support arm having a distal end and a proximal end. The support arm is coupled to the clevis with a hinge assembly.

The hinge assembly comprises a connector coupled to a first hinge and a second hinge. The connector comprises a proximal end and a distal end. The distal end includes a recess configured to rotatably receive the proximal end of the support arm.

The first hinge rotateably couples the connector to the clevis. The second hinge rotateably couples the support arm to the connector. The support arm is rotatable about the first hinge and the second hinge.

Embodiments described herein include a method comprising configuring a cross member with an attaching region in each of a first end and a second end. Each attaching region is configured to receive a fastener. The method includes forming an assembly by attaching a first bracket to the attaching region of the first end and attaching a second bracket to the attaching region of the second end. The method includes attaching a hanger component to at least one of the cross member, the first bracket, and the second bracket. The method includes adjusting a position of each of the first bracket and the second bracket relative to the cross member. The adjusted position is configured to exert a securing force that secures the assembly to a vertical support of a structure. The method includes adjusting a position of the assembly on the vertical support.

Embodiments described herein include a method comprising: configuring a cross member with an attaching region in each of a first end and a second end, where each attaching region is configured to receive a fastener; forming an assembly by attaching a first bracket to the attaching region of the first end and attaching a second bracket to the attaching region of the second end; attaching a hanger component to at least one of the cross member, the first bracket, and the second bracket; adjusting a position of each of the first bracket and the second bracket relative to the cross member, wherein the adjusted position is configured to exert a securing force that secures the assembly to a vertical support of a structure; and adjusting a position of the assembly on the vertical support.

The method comprises configuring the assembly as selectively adjustable to a position along the vertical support of the hoist member.

The method comprises configuring the hanger component to support hanging of a wheel on the hoist member.

The method comprises forming the hanger component to include a clevis, and forming the clevis to include a top plate that is substantially parallel to a bottom plate and connected to the bottom plate with a base plate.

The method comprises forming the hanger component to include a support arm having a distal end and a proximal end, and coupling the support arm to the clevis with a hinge assembly.

The method comprises forming the hinge assembly to include a connector coupled to a first hinge and a second hinge.

The method comprises forming the connector to include a proximal end, and a distal end that includes a recess configured to rotatably receive the proximal end of the support arm.

The method comprises forming the first hinge to rotateably couple the connector to the clevis, and the second hinge to rotateably couple the support arm to the connector, wherein the support arm is rotatable about the first hinge and the second hinge.

The method comprises coupling the hanger component to the cross member using at least one fastener.

The method comprises configuring the cross member with a first insert in the first end and a second insert in the second end, and configuring each of the first insert and the second insert to receive at least one fastener that fastens the first bracket and the second bracket to the cross member.

The method comprises configuring the first end of each of the first bracket and the second bracket to include at least one aperture, wherein the at least one aperture is configured to receive the at least one fastener and control the positional adjustment of each of the first bracket and the second bracket relative to the cross member.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods is not intended to be exhaustive or to limit the systems and methods to the precise forms disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above.

The elements and acts of the various embodiments described above can be combined to provide further embodiments. These and other changes can be made to the systems and methods in light of the above detailed description.

What is claimed is:

1. An apparatus comprising:
a cross member;
a clamp comprising a first end configured to be fastened to the cross member and a second end configured to make secure contact with a vertical support structure;
a hinge comprising a proximal end and a distal end, wherein the proximal end is configured to be coupled to the cross member to rotate around the cross member coupling in a first plane; and
a support arm assembly comprising a socket and a support arm extending from the socket, wherein the socket is configured to be coupled to the distal end of the hinge to rotate around the hinge coupling in a second plane that is different from the first plane.

2. The apparatus of claim 1, comprising:
an additional clamp configured to fasten the cross member to the vertical support structure;
an additional hinge comprising a proximal end configured to be coupled to the cross member to rotate around the cross member coupling in the first plane; and
an additional support arm assembly comprising an additional socket and an additional support arm extending from the socket, wherein the additional socket is configured to be coupled to a distal end of the additional hinge to rotate around the additional hinge coupling in the second plane.

3. The apparatus of claim 1, comprising a parts tray configured to be coupled to the cross member.

4. An apparatus comprising:
a cross member comprising a first end and a second end;
a first bracket comprising a first end configured to be fastened to the first end of the cross member and a second end configured to be free of attachment;
a second bracket comprising a first end configured to be fastened to the second end of the cross member and a second end configured to be free of attachment, wherein the first bracket and the second bracket are configured for positional adjustment relative to a position of the cross member and a vertical support of a hoist, wherein an assembly comprising the cross member fastened to the first bracket and the second bracket is configured to exert a securing force that secures the assembly to the vertical support of the hoist member; and
a hanger component coupled to at least one of the cross member, the first bracket, and the second bracket.

5. The apparatus of claim 4, wherein the cross member comprises a first insert in the first end and a second insert in the second end, where each of the first insert and the second insert are configured to receive at least one fastener that fastens the first bracket and the second bracket to the cross member.

6. The apparatus of claim 5, wherein the first end of each of the first bracket and the second bracket comprises at least one aperture that is configured to receive the at least one fastener and control the positional adjustment of each of the first bracket and the second bracket relative to the cross member.

7. The apparatus of claim 5, where the cross member comprises a tubular member.

8. The apparatus of claim 5, wherein the first bracket comprises an L-shaped bracket formed as a single component, and the second bracket comprises an L-shaped bracket formed as a single component.

9. The apparatus of claim 4, wherein the assembly is configured to be selectively adjusted to a position along the vertical support of the hoist member.

10. The apparatus of claim 4, wherein the hanger component is configured for hanging a wheel on the hoist member.

11. The apparatus of claim 4, wherein the hanger component comprises a clevis comprising a top plate that is substantially parallel to a bottom plate and connected to the bottom plate with a base plate.

12. The apparatus of claim 11, wherein the hanger component comprises a support arm having a distal end and a proximal end, wherein the support arm is coupled to the clevis with a hinge assembly.

13. The apparatus of claim 12, wherein the hinge assembly comprises a connector coupled to a first hinge and a second hinge.

14. The apparatus of claim 13, wherein the connector comprises a proximal end and a distal end, wherein the distal end includes a recess configured to rotatably receive the proximal end of the support arm.

15. The apparatus of claim 14, wherein the first hinge rotateably couples the connector to the clevis, and the second hinge rotateably couples the support arm to the connector, wherein the support arm is rotatable about the first hinge and the second hinge.

16. The apparatus of claim 10, wherein the hanger component is coupled to the cross member with at least one fastener.

17. An apparatus comprising:
a cross member comprising a first end and a second end, wherein each of the first end and the second end include an insert configured to receive a fastener;
a first bracket comprising a first end configured to be fastened to the insert in the first end of the cross member;
a second bracket comprising a first end configured to be fastened to the insert in the second end of the cross member, wherein the first bracket and the second bracket are configured for positional adjustment relative to a position of the cross member, wherein an assembly comprising the cross member fastened to the first bracket and the second bracket is configured to exert a securing force that secures the assembly to a vertical support of a structure; and
a hanger component coupled to at least one of the cross member, the first bracket, and the second bracket.

18. The apparatus of claim 17, wherein the assembly is configured to be selectively adjusted to a position along the vertical support.

19. The apparatus of claim 17, wherein the first bracket comprises an L-shaped bracket formed as a single component, and the second bracket comprises an L-shaped bracket formed as a single component.

20. The apparatus of claim 17, wherein the hanger component comprises a clevis comprising a top plate that is substantially parallel to a bottom plate and connected to the bottom plate with a base plate.

21. The apparatus of claim 20, wherein the hanger component comprises a support arm having a distal end and a proximal end, wherein the support arm is coupled to the clevis with a hinge assembly.

22. The apparatus of claim 21, wherein the hinge assembly comprises a connector coupled to a first hinge and a second hinge, wherein the connector comprises a proximal end and a distal end, wherein the distal end includes a recess configured to rotatably receive the proximal end of the support arm.

23. The apparatus of claim 22, wherein the first hinge rotateably couples the connector to the clevis, and the second hinge rotateably couples the support arm to the connector, wherein the support arm is rotatable about the first hinge and the second hinge.

24. A method comprising:
configuring a cross member with an attaching region in each of a first end and a second end, where each attaching region is configured to receive a fastener;
forming an assembly by attaching a first bracket to the attaching region of the first end and attaching a second bracket to the attaching region of the second end;
attaching a hanger component to at least one of the cross member, the first bracket, and the second bracket;
adjusting a position of each of the first bracket and the second bracket relative to the cross member, wherein the adjusted position is configured to exert a securing force that secures the assembly to a vertical support of a structure; and
adjusting a position of the assembly on the vertical support.

25. The method of claim 24, comprising configuring the assembly as selectively adjustable to a position along the vertical support of the hoist member.

26. The method of claim 24, comprising configuring the hanger component to support hanging of a wheel on the hoist member.

27. The method of claim 24, comprising forming the hanger component to include a clevis, and forming the clevis to include a top plate that is substantially parallel to a bottom plate and connected to the bottom plate with a base plate.

28. The method of claim 27, comprising forming the hanger component to include a support arm having a distal end and a proximal end, and coupling the support arm to the clevis with a hinge assembly.

29. The method of claim 28, comprising forming the hinge assembly to include a connector coupled to a first hinge and a second hinge.

30. The method of claim 29, comprising forming the connector to include a proximal end, and a distal end that includes a recess configured to rotatably receive the proximal end of the support arm.

31. The method of claim 30, comprising forming the first hinge to rotateably couple the connector to the clevis, and the second hinge to rotateably couple the support arm to the connector, wherein the support arm is rotatable about the first hinge and the second hinge.

32. The method of claim 24, comprising coupling the hanger component to the cross member using at least one fastener.

33. The method of claim 24, comprising configuring the cross member with a first insert in the first end and a second insert in the second end, and configuring each of the first insert and the second insert to receive at least one fastener that fastens the first bracket and the second bracket to the cross member.

34. The method of claim 33, comprising configuring the first end of each of the first bracket and the second bracket to include at least one aperture, wherein the at least one aperture is configured to receive the at least one fastener and control the positional adjustment of each of the first bracket and the second bracket relative to the cross member.
